(19) United States
(12) Patent Application Publication
(10) Pub. No.: US 2023/0259549 A1
(43) Pub. Date: Aug. 17, 2023

(54) EXTRACTION OF FEATURE POINT OF OBJECT FROM IMAGE AND IMAGE SEARCH SYSTEM AND METHOD USING SAME

(71) Applicant: Seung Mo KIM, Gimpo-si, Gyeonggi-do (KR)

(72) Inventor: Seung Mo KIM, Gimpo-si, Gyeonggi-do (KR)

(21) Appl. No.: 18/015,875

(22) PCT Filed: Jul. 20, 2021
(86) PCT No.: PCT/KR2021/009301

§ 371 Date: Jan. 12, 2023

(30) Foreign Application Priority Data
Jul. 24, 2020 (KR) 10-2020-0092185

(51) Int. Cl. G06F 16/583; G06T 7/70; G06V 10/44; G06V 10/74

(52) U.S. Cl. CPC G06F 16/583; G06T 7/70; G06V 10/44; G06V 10/761; G06V 2201/07

(57) ABSTRACT

The present disclosure relates to an image search system and method using extraction of a feature point of an object from an image. More specifically, the present disclosure relates to an image search system and method using extraction of a feature point of an object from an image in order to extract an object and a feature point from an image and turn the object and the feature point into big data, and extract an image satisfying a search condition and provide the image.

### TECHNICAL FIELD

The present disclosure relates to an image search system and method using extraction of a feature point of an object from an image. More specifically, the present disclosure relates to an image search system and method using extraction of a feature point of an object from an image in order to extract an object and a feature point from an image and turn the object and the feature point into big data, and extract an image satisfying a search condition and provide the image.

### BACKGROUND ART

In general, surveillance systems are built for various purposes, such as facility management, crime prevention, and security. A surveillance system includes surveillance cameras (CCTV: closed-circuit television) fixedly installed at various places and a server for storing images obtained by the surveillance cameras, and restores images of a particular area or a particular time period for checking in response to a user's request.

However, according to a conventional surveillance system, it is possible to find an image showing a time or a location desired, but it is difficult to search for a behavior type of a particular pattern of an object in an image. For example, when trying to find a person with particular features and clothes (wearing a blue top) who entered and exited a building between particular dates (12 Aug. 2015˜13 Aug. 2015), the conventional surveillance system can obtain only an image of the period captured by a surveillance camera installed toward an emergency exit, so a user needs to find the person in the image manually by adjusting the playback speed of the image, for example.

Therefore, in the conventional surveillance system, finding an object satisfying a particular search condition within an image requires lots of time and labor, and a search process needs to be repeated when the search condition is changed. That is, it is difficult to search for an object with a behavior type of a particular pattern within an image. (Patent Document 1: KR10-2017-0037917 A) makes up for these problems, and these problems will be described in detail with reference to (Patent Document 1: KR10-2017-0037917 A).

(Patent Document 1: KR10-2017-0037917 A) relates to a method and an apparatus for searching for an object in an image obtained from a fixed camera. According to this, the apparatus includes: an input part for receiving images captured by a fixedly installed camera; a search setting part for setting a search area and a search condition for searching for an object included in the images; an object search part for searching for the object corresponding to the search condition and the search area among a plurality of the objects included in the images, and for tracking the found object to extract the image including the found object among the images; and an output part for synthesizing a marker for tracking the found object into the extracted image and outputting an synthesized image.

However, (Patent Document 1: KR10-2017-0037917 A) includes a technical element for extracting an object included in an image and searching for the extracted object, and has a problem that search requirements are not intermittently satisfied even if an object is extracted, or an image search system does not operate properly due to a recognition error.

### DISCLOSURE

### Technical Problem

The present disclosure is directed to providing an image search system and method using extraction of a feature point of an object from an image in order to extract an object and a feature point from an image and turn the object and the feature point into big data, and extract an image satisfying a search condition and provide the image.

### Technical Solution

In order to solve the above problems,

according to an embodiment of the present disclosure, there is provided an image search system using extraction of a feature point of an object from an image, the system including: an image collection part configured to collect image data collected through at least one camera, or to collect image data separately input;

an object detection part configured to detect an object included in an image collected by the image collection part;

a feature extraction part configured to extract a feature point of the object detected by the object detection part, and to determine a proper noun of the object on the basis of the feature point;

a database configured to store therein the proper noun of the object determined by the feature extraction part and data of the object extracted by the object detection part, and to turn the proper noun of the object and the data of the object into big data;

an image search part configured to compare the object of the image for search, the feature point of the object, and the proper noun of the object with at least one object, a feature point of the at least one object, and a proper noun of the at least one object stored in the database for matching, and to search for an image included in the at least one object, the feature point of the at least one object, and the proper noun of the at least one object that are matched; and

an image extraction part configured to extract, from the database, the at least one image extracted by the image search part.

In addition, in the image search system using extraction of a feature point of an object from an image according to an embodiment of the present disclosure, the object detection part may be configured to detect the object included in the image using a You Only Look Once (YOLO) object detection algorithm.

In addition, in the image search system using extraction of a feature point of an object from an image according to an embodiment of the present disclosure, the feature extraction part may be configured to use a deep learning-based object detection algorithm for the at least one object detected by the object detection part to extract the at least one feature point of the at least one object.

In addition, in the image search system using extraction of a feature point of an object from an image according to an embodiment of the present disclosure, the image search part may be configured to detect the object of the image for search, through the object detection part, and to detect the feature point of the object and the proper noun of the object, through the feature extraction part.

According to an embodiment of the present disclosure, there is provided an image search method using extraction of a feature point of an object from an image, the method including: (a) collecting, by an image collection part, image data collected from at least one camera;

(b) detecting, by an object detection part, at least one object included in the image data;

(c) extracting, by a feature extraction part, a feature point of the at least one object detected by the object detection part, and determining a proper noun of the least one object on the basis of the extracted feature point;

(d) performing comparison with information stored in a database on the basis of information extracted by the object detection part and the feature extraction part, and searching for an image corresponding to a comparison result by an image search part; and

(e) extracting the at least one image found by the image search part from the database.

In addition, in the image search method using extraction of a feature point of an object from an image according to an embodiment of the present disclosure, in the step (b), the object included in the image may be detected using a You Only Look Once (YOLO) object detection algorithm.

In addition, in the image search method using extraction of a feature point of an object from an image according to an embodiment of the present disclosure, in the step (c), a deep learning-based object detection algorithm may be used for the at least one object detected by the object detection part to extract the at least one feature point of the at least one object.

In addition, in the image search method using extraction of a feature point of an object from an image according to an embodiment of the present disclosure, in the step (d), the object included in the image for search may be extracted by the object detection part and the feature point of the object and the proper noun of the object may be extracted by the feature extraction part, and the extracted object, the feature point of the extracted object, and the proper noun of the extracted object may be compared with the information stored in the database (an object, a feature point of the object, and a proper noun of the object stored in the database).

These solutions will become more apparent from the following detailed description of the disclosure with reference to the accompanying drawings.

The terms and words used in the present specification and claims should not be interpreted as being limited to typical meanings or dictionary definitions, but should be interpreted as having meanings and concepts relevant to the technical scope of the present disclosure based on the rule according to which an inventor can appropriately define the concept of the term to describe most appropriately the best method he or she knows for carrying out the disclosure.

### Advantageous Effects

According to an embodiment of the present disclosure, an object extracted from an image, a feature point of the object, and a proper noun of the object are extracted using a deep learning-based object detection algorithm, and the object, the feature point, and the proper noun are stored in the database and turned into big data. Information corresponding to an image for search can be extracted from the database.

In addition, according to an embodiment of the present disclosure, information on an object included in an image can be calculated using artificial intelligence, and the information is used to obtain big data.

### DESCRIPTION OF DRAWINGS

FIG. 1 is a block diagram illustrating an image search system using extraction of a feature point of an object from an image according to an embodiment of the present disclosure.

FIG. 2 is a flowchart illustrating an image search method using extraction of a feature point of an object from an image according to an embodiment of the present disclosure.

### MODE FOR INVENTION

Specific aspects and technical features of the present disclosure will become more apparent from the following description of embodiments with reference to the accompanying drawings. It is to be noted that in assigning reference numerals to elements in the drawings, the same reference numerals designate the same elements throughout the drawings although the elements are shown in different drawings. In addition, in the description of the present disclosure, the detailed descriptions of known related constitutions or functions thereof may be omitted if they make the gist of the present disclosure unclear.

Further, when describing the elements of the present disclosure, terms such as first, second, A, B, (a) or (b) may be used. Since these terms are provided merely for the purpose of distinguishing the elements from each other, they do not limit the nature, sequence or order of the elements. It will be understood that when an element is referred to as being “coupled to”, “combined with”, or “connected to” another element, it can be directly coupled or connected to the element, or intervening elements can be “coupled”, “combined”, or “connected” therebetween.

Hereinafter, an embodiment of the present disclosure will be described in detail with reference to the accompanying drawings.

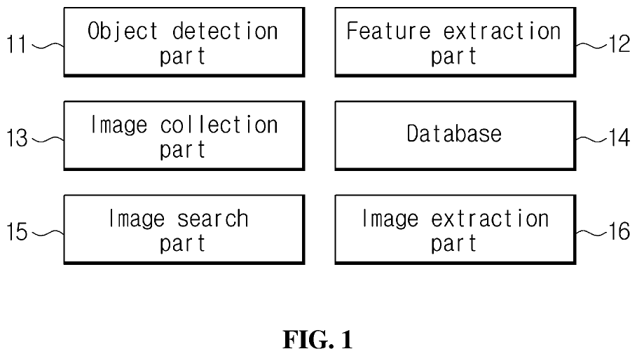

As shown in FIG. 1, according to an embodiment of the present disclosure, a system for extraction of a feature point of an object from an image may include: an image collection part 13 for collecting image data collected through at least one camera; an object detection part 11 for detecting an object included in an image collected by the image collection part 13; a feature extraction part 12 for extracting a feature point of the object extracted by the object detection part 11, and determining a proper noun of the object on the basis of the feature point; and a database 14 for storing the proper noun of the object determined by the feature extraction part 12 and data of the object extracted by the object detection part 11, and turning the proper noun and the data of the object into big data.

The image collection part 13 performs a function of receiving image data collected through the at least one camera and collecting the image data. The image collection part 13 and the camera may be connected through a separate wire.

A camera is any one selected from the group of an RGN camera, a 3D depth camera, an IR camera, and a spectral camera. In the present disclosure, image data captured by an IR camera may be collected.

In addition, the image collection part 13 may collect image data through a camera, and may separately collect image data input from the outside. Herein, the image collection part 13 may receive image data from a separate device (or server). In the present disclosure, the image collection part 13 may be used when collecting image data for search.

The object detection part 11 performs a function of detecting at least one object from an image collected by the image collection part 13. The object detection part 11 may include a You Only Look Once (YOLO) object detection algorithm in which a raw image or video is divided into grid cells of the same size, the number of bounding boxes specified in a predefined shape at the center of each grid cell resulting from division is predicted, and on the basis of the number, reliability is calculated and an object is detected.

The object detection part 11 may detect at least one object included in an image by time and may display time and an object together.

The feature extraction part 12 may perform a function of extracting a feature point of each object for at least one object detected by the object detection part 11, and determining a proper noun of the object on the basis of the extracted feature point.

Specifically, the feature extraction part 12 may use a deep learning-based object detection algorithm to extract at least one feature point of an object. Herein, the deep learning-based object detection algorithm may be interpreted as an algorithm the same as the YOLO object detection algorithm.

In addition, on the basis of an extracted feature point of an object, the feature extraction part 12 may infer a proper noun, such as, a car, a tree, a building, and the like, of the object.

After an object by time is extracted from an image by the object detection part 11 and a feature point of the object and a proper noun of the object are extracted by the feature extraction part 12, the object by time, the feature point of the object, and the proper noun of the object may be separately stored in the database 14.

The database 14 may store therein information (an object, a feature point of the object, and a proper noun of the object) extracted by the object detection part 11 and the feature extraction part 12, and may turn the information into big data.

According to an embodiment of the present disclosure, an image search system using a feature point of an object from an image includes: an image search part 15 for comparing an object of an image for search, a feature point of the object, and a proper noun of the object with information stored in the database 14 for matching, and searching for an image included in an object, a feature point of the object, and a proper noun of the object that are matched; and an image extraction part 16 for extracting, from the database 14, at least one image extracted by the image search part 15.

The image search part 15 may perform a function of searching for information stored in the database 14.

Specifically, the image search part 15 may perform a function of extracting an object of an image for search, a feature point of the object, and a proper noun of the object by using the object detection part 11 and the feature extraction part 12, and of comparing the extracted object, the feature point of the extracted object, and the proper noun of the extracted object with an object, a feature point of the object, and a proper noun of the object stored in the database to search for an image corresponding to the object of the image for search, the feature point of the object, and the proper noun of the object.

For example, when there is a matched image, the image extraction part 16 may extract the image from the database 14.

In addition, the image search part 15 may store information (an object, a feature point of the object, and a proper noun of the object) extracted from an image for search, separately in the database 14, so that the information is turned into big data.

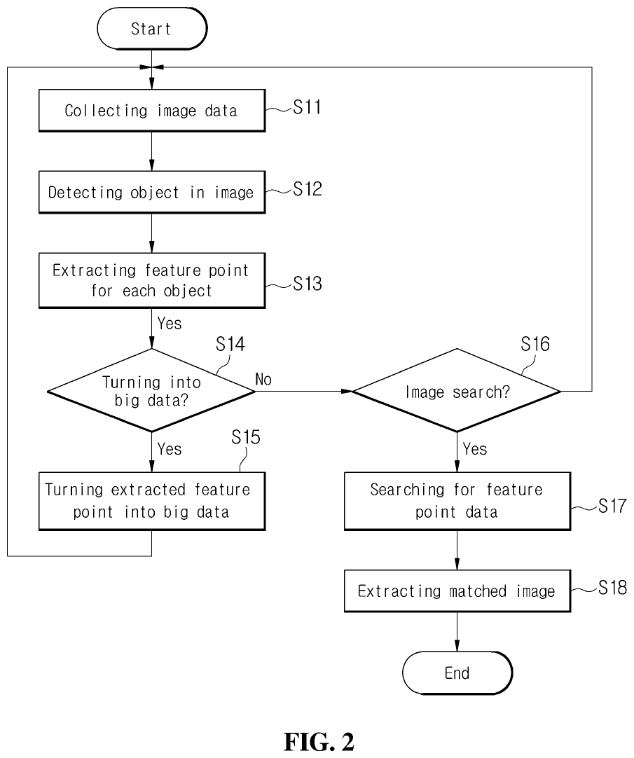

As shown in FIGS. 1 and 2, according to an embodiment of the present disclosure, there is provided an image search method using extraction of a feature point of an object from an image, the method including: collecting image data in step S11; detecting an object in an image in step S12; extracting a feature point for each object in step S13; storing the extracted feature point in steps S14 and S15; searching a database for an image in steps S16 and 17; extracting the image matched in step S18.

First, in the collecting of the image data in step S11, the image may be collected through an image collection part 13. Specifically, a function of receiving image data collected through at least one camera and collecting the image data may be performed. The image collection part 13 and the camera may be connected through a separate wire.

A camera is any one selected from the group of an RGN camera, a 3D depth camera, an IR camera, and a spectral camera. In the present disclosure, image data captured by an IR camera may be collected.

In addition, the image collection part 13 may collect image data through a camera, and may separately collect image data input from the outside. Herein, the image collection part 13 may receive image data from a separate device (or server). In the present disclosure, the image collection part 13 may be used when collecting image data for search.

An object detection part 11 may detect an object from an image collected by the image collection part 13 in step S12. Specifically, the object detection part 11 performs a function of detecting at least one object from an image collected by the image collection part 13. The object detection part 11 may include a You Only Look Once (YOLO) object detection algorithm in which a raw image or video is divided into grid cells of the same size, the number of bounding boxes specified in a predefined shape at the center of each grid cell resulting from division is predicted, and on the basis of the number, reliability is calculated and an object is detected.

The object detection part 11 may detect at least one object included in an image by time and may display time and an object together.

From at least one object detected by the object detection part 11, a feature extraction part 12 may extract a feature point of the object in step S13. Specifically, the feature extraction part 12 may perform a function of extracting a feature point of each object for at least one object detected by the object detection part 11, and determining a proper noun of the object on the basis of the extracted feature point.

Specifically, the feature extraction part 12 may use a deep learning-based object detection algorithm to extract at least one feature point of an object. Herein, the deep learning-based object detection algorithm may be interpreted as an algorithm the same as the YOLO object detection algorithm.

In addition, on the basis of an extracted feature point of an object, the feature extraction part 12 may infer a proper noun, such as, a car, a tree, a building, and the like, of the object.

After an object by time is extracted from an image by the object detection part 11 and a feature point of the object and a proper noun of the object are extracted by the feature extraction part 12, the object by time, the feature point of the object, and the proper noun of the object may be separately stored in the database 14 in step S14.

The database 14 may store therein information (an object, a feature point of the object, and a proper noun of the object) extracted by the object detection part 11 and the feature extraction part 12, and may turn the information into big data in step S15.

In the meantime, when the information extracted by the object detection part 11 and the feature extraction part 12 is extracted to search for information stored in the database 14 in step S16, comparison with information stored in the database 14 is performed on the basis of the information extracted by the object detection part and the feature extraction part and an image search part 15 searches for an image corresponding to a comparison result in step S17.

Specifically, the image search part 15 may perform a function of extracting an object of an image for search, a feature point of the object, and a proper noun of the object by using the object detection part 11 and the feature extraction part 12, and of comparing the extracted object, the feature point of the extracted object, and the proper noun of the extracted object with an object, a feature point of the object, and a proper noun of the object stored in the database to search for an image corresponding to the object of the image for search, the feature point of the object, and the proper noun of the object.

When a matched image is found in the above manner, the image extraction part 16 may extract the matched image from the database 14 in step S18.

That is, according to an embodiment of the present disclosure, an object extracted from an image, a feature point of the object, and a proper noun of the object are extracted using a deep learning-based object detection algorithm, and the object, the feature point, and the proper noun are stored in the database 14 and turned into big data. Information corresponding to an image for search may be extracted from the database.

Although the present disclosure have been described in detail with the embodiments of, this is for describing the present disclosure in detail. An image search system and method using extraction of a feature point of an object from an image according to the present disclosure are not limited thereto. Further, it should be understood that terms such as “comprise”, “include”, or “have” are merely intended to indicate that the corresponding element is internally present, unless a description to the contrary is specifically pointed out in context, and are not intended to exclude the possibility that other elements may be additionally included. Unless differently defined, all terms used here including technical or scientific terms have the same meanings as the terms generally understood by those skilled in the art to which the present disclosure pertains.

The above description is merely intended to exemplarily describe the technical spirit of the present disclosure, and those skilled in the art will appreciate that various changes and modifications are possible without departing from the essential features of the present disclosure. Therefore, the embodiments disclosed in the present disclosure are not intended to restrict the technical spirit of the present disclosure and are merely intended to describe the present disclosure, and the scope of the present disclosure is not limited by those embodiments. The protection scope of the present disclosure should be defined by the accompanying claims, and the technical spirit of all equivalents thereof should be construed as being included in the scope of the present disclosure.

### INDUSTRIAL APPLICABILITY

There is industrial applicability to the field of an image search and extraction system and method.

1. An image search system using extraction of a feature point of an object from an image, the system comprising:
an image collection part configured to collect image data collected through at least one camera, or to collect image data separately input;
an object detection part configured to detect an object included in an image collected by the image collection part;
a feature extraction part configured to extract a feature point of the object detected by the object detection part, and to determine a proper noun of the object on the basis of the feature point;
a database configured to store therein the proper noun of the object determined by the feature extraction part and data of the object extracted by the object detection part, and to turn the proper noun of the object and the data of the object into big data;
an image search part configured to compare the object of the image for search, the feature point of the object, and the proper noun of the object with at least one object, a feature point of the at least one object, and a proper noun of the at least one object stored in the database for matching, and to search for an image included in the at least one object, the feature point of the at least one object, and the proper noun of the at least one object that are matched; and
an image extraction part configured to extract, from the database, the at least one image extracted by the image search part.

2. The system of claim 1, wherein the object detection part is configured to detect the object included in the image using a You Only Look Once (YOLO) object detection algorithm.

3. The system of claim 2, wherein the feature extraction part is configured to use a deep learning-based object detection algorithm for the at least one object detected by the object detection part to extract the at least one feature point of the at least one object.

4. The system of claim 1, wherein the image search part is configured to detect the object of the image for search, through the object detection part, and to detect the feature point of the object and the proper noun of the object, through the feature extraction part.

5. An image search method using extraction of a feature point of an object from an image, the method being configured to implement the image search system using extraction of a feature point of an object from an image according to claim 1 and the method comprising:
(a) collecting, by an image collection part, image data collected from at least one camera;
(b) detecting, by an object detection part, at least one object included in the image data;
(c) extracting, by a feature extraction part, a feature point of the at least one object detected by the object detection part, and determining a proper noun of the least one object on the basis of the extracted feature point;
(d) performing comparison with information stored in a database on the basis of information extracted by the object detection part and the feature extraction part, and searching for an image corresponding to a comparison result by an image search part; and
(e) extracting the at least one image found by the image search part from the database.

6. The method of claim 5, wherein in the step (b), the object included in the image is detected using a You Only Look Once (YOLO) object detection algorithm.

7. The method of claim 6, wherein in the step (c), a deep learning-based object detection algorithm is used for the at least one object detected by the object detection part to extract the at least one feature point of the at least one object.

8. The method of claim 6, wherein in the step (d), the object included in the image for search is extracted by the object detection part and the feature point of the object and the proper noun of the object are extracted by the feature extraction part, and the extracted object, the feature point of the extracted object, and the proper noun of the extracted object are compared with the information stored in the database (an object, a feature point of the object, and a proper noun of the object stored in the database).
